(19) United States
(12) Patent Application Publication
(10) Pub. No.: US 2007/0005166 A1
(43) Pub. Date: Jan. 4, 2007

(54) Automated manufacturing systems and processes utilizing the 802.11a wireless standard protocol

(76) Inventors: Yilong Chen, Farmington Hills, MI (US); Fangming Gu, Rochester Hills, MI (US); David B. Berger, Plymouth, MI (US); Frank Gajor, Livonia, MI (US); Joel Bias, Southgate, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/171,627

(22) Filed: Jun. 30, 2005

(51) Int. Cl. G06F 19/00

(52) U.S. Cl. 700/96; 700/7; 709/230

(57) ABSTRACT

Provided herein are systems useful in a manufacturing environment for transmitting operational commands to one or more workstations at which a workpiece is being acted upon by one or more pieces of manufacturing process equipment. A system according to the invention utilizes the 802.11a communication standard in conveying command signals wirelessly from a source to a programmable logic controller that is adapted to control the actions of a piece of manufacturing process equipment. A system according to the invention is adaptable to multiple-stage manufacturing operations through use of a plurality of receiving stations which are each equipped with a wireless modem in cooperative connection with a programmable logic controller that controls a particular piece of manufacturing process equipment at each stage. Systems and processes according to the invention are applicable to nearly any manufacturing process, and allow increased flexibility in management and configuration of manufacturing operations, while conferring a high degree of portability in many cases.

### TECHNICAL FIELD

The present invention relates generally to manufacturing process automation systems and methods. More particularly, it relates to methods for employing wireless local area network technology for communicating control information between one or more programmable logic controllers and data between a programmable logic controller and an information technology system.

### BACKGROUND OF THE INVENTION

Sophisticated industrial manufacturing and control processes often require the cooperative and well-timed execution of numerous interdependent tasks by many different pieces of equipment. The complexity of ensuring proper task sequencing and management requires not only procedural logic, but also constant monitoring of equipment states to organize and distribute operations and detect malfunctions.

Today, many industries use programmable logic controllers to properly operate and monitor elaborate industrial equipment and processes. Programmable logic controllers operate in accordance with a stored control program that causes the controller to examine the state of the controlled machinery by evaluating signals from one or more sensing devices (e.g., temperature or pressure sensors), and to operate the machinery (e.g., by energizing or de-energizing operative components) based on a procedural framework, the sensor signals and, if necessary, more complex processing.

Ordinarily, process operation is monitored, at least intermittently, by supervisory personnel by means of one or more central management stations. Each station samples the status of controllers (and their associated sensors) selected by the operator and presents the data in some meaningful format. The management station may or may not be located on the same site as the monitored equipment; frequently, one central station has access to multiple sites (whether or not these perform related processes). Accordingly, communication linkage can be vital even in traditional industrial environment where process equipment is physically proximate, since at least some supervisory personnel may not be.

To facilitate the necessary communication, the controller and related computers (such as monitoring stations) are arranged as a computer network that uses some consistent protocol to communicate with one another. The communication protocol provides the mechanism by decomposing and routing messages to a destination computer identified by an address. The protocol may place a “header” of routing information on each component of a message that specifies source and destination addresses, and identifies the component to facilitate later reconstruction of the entire message by the destination computer. This approach to data transfer permits the network to rapidly and efficiently handle large communication volumes without reducing transfer speed in order to accommodate long individual message.

In typical computer networks having one or more programmable logic controllers, a monitoring computer, which may be remotely located from any or all of the controllers to which it has access, periodically queries the controllers to obtain data descriptive of the controlled process or machine, or the controller itself. This data is then available for analysis by the monitoring computer.

In 1997 the Institute of Electrical and Electronics Engineers created the first wLAN standard, called 802.11 after the name of the group formed to oversee its development. 802.11 only supported a maximum bandwidth of 2 Mbps, which was too slow for most applications, and IEEE expanded on the original 802.11 standard in 1999, creating the 80-2.11b specification.

When 802.11b was developed, IEEE created a second extension to the original 802.11 standard called 802.11a. 802.11a wireless networks support a maximum theoretical bandwidth of 54 Mbps.

The principal advantage of 802.11a over 802.11b as viewed by many is improved performance. However, 802.11a access points (APs) and adapters also cost significantly more to produce than their 802.11b counterparts, and an 802.11a access point transmitter may cover less area than a comparable 802.11b AP. Nevertheless, owing in part to its improved performance and reduction of interference, by transmitting radio signals in the frequency range above 5 GHz, 802.11a is preferred for use in a system according to the invention, despite the fact that the range of an 802.11a signal is limited by use of the high 5 GHz frequency. For example, brick walls and other obstructions affect 802.11a wireless networks to a greater degree than they do comparable 802.11b networks, and while viewed as negative by many for end-use applications, use of this standard has been found to have a synergistic benefit when employed in a system according to the invention. This is due in part, as will be appreciated by one of ordinary skill after reading and understanding the contents of this specification and the appended claims, that the 802.11a's limited ability also functions to protect a system of the present invention from interferences outside the present system, especially interferences through walls which would otherwise be problematic to the extent of non-functionality of the systems we describe herein.

At present, there are no wLAN-EtherNet enabled programmable logic controllers on the market. The lack of a PCMCIA-like adapter for programmable logic controllers (“PLC's”) has prevented 802.11a to be used for PLC control. This has meant that the use of wireless communication between multiple PLC's has not been yet realized. The present invention is the first to provide systems embodying such architecture.

Use of a system according to the present invention opens the door for wLAN to be adopted for PLC real-time control applications which are commonly used in many aspects of modem manufacturing automation, while providing flexibility for the arrangement of PLC applications and locations by eliminating the need to run cable. Systems according to the invention also have the advantage of reduced overall costs associated with initial installation and maintenance costs, while allowing for ready disassembly and portability. The use of other standards such as 802.11b/11g for communication in the same manufacturing zone is preserved. These and other advantages provided the present invention and legal equivalents thereof will become apparent to one of ordinary skill in this art upon reading and understanding of this specification and the claims appended hereto.

### SUMMARY OF THE INVENTION

The present invention provides systems useful in controlling a wide range of possible manufacturing operations. One system according to the invention comprises a command-transmitting substation which itself comprises i) a network router that is preferably capable of functioning as a switch; ii) a first programmable logic controller connected to the network router; and iii) a first wireless network adapter connected to the network router. There is also a command-receiving substation which itself comprises: i) a second wireless network adapter; and ii) a second programmable logic controller connected to the second wireless network adapter. In one mode of operation, the first wireless network adapter transmits electromagnetic signals containing command information to the second wireless network adapter acting as a receiver for the signals, under the 802.11a standard protocol. The router may optionally be connected to a computer network. In a preferred embodiment, at least one of the programmable logic controllers and wireless network adapter to which it is connected may both be embedded in a single electronic device.

It is also possible to add further command receiving substations to the embodiment described in the foregoing paragraph, thus, a system according to the invention may further comprise at least a second command-receiving substation which comprises a wireless network adapter and a programmable logic controller connected to one another wherein this additional command-receiving substation receives signals from the first wireless network adapter according to the 802.11a standard protocol. The number of possible added additional receiving sub-stations may be any number up to about 25.

Other embodiments include those provided by adding a computer interface connected to the router, which computer interface comprises a microprocessor, storage means and a display.

The present invention also includes systems capable of ad hoc operation of a manufacturing process using the 802.11a protocol between a command center and a receiving station comprising a programmable logic controller. Such ad hoc systems may include a command-transmitting substation which itself comprises: a first programmable logic controller; a first wireless network adapter connected to the first programmable logic controller; and a command-receiving substation which comprises: a second programmable logic controller; and a second wireless network adapter connected to the second programmable logic controller. In such an embodiment, the first wireless network adapter transmits electromagnetic signals containing command information to the second wireless network adapter acting as a receiver for the signals, under the 802.11a standard protocol. The first programmable logic controller and the first wireless network adapter may both be optionally embedded in a single electronic device. In an alternate form of this embodiment, all programmable logic controllers and their associated wireless network adapters are embedded in a single electronic device.

Thus, the invention further comprises processes for controlling a manufacturing process that operates on a workpiece, utilizing the 802.11a wireless standard, which processes include the steps of: a) providing a programmable logic controller; b) providing a piece of equipment useful in a manufacturing process, wherein the piece of equipment is in effective electrical contact with said programmable logic controller sufficient that the programmable logic controller is capable of controlling the function of the piece of equipment; c) providing a first wireless modem in effective electrical contact with the programmable logic controller; d) providing a second wireless modem which is capable of communicating with the first wireless modem; e) providing a computer interface in effective communicating electrical contact with the second wireless modem; and f) transmitting a function command from the second wireless modem to the first wireless modem, sufficient to cause an action in said piece of equipment.

### BRIEF DESCRIPTION OF THE DRAWINGS

FIG. 1 shows a programmable control system according to one embodiment of the present invention;

FIG. 2 shows a programmable control system according to an alternate embodiment of the present invention;

FIG. 3 shows a programmable control system according to another alternate embodiment of the invention;

FIG. 4 shows a programmable control system according to a further alternate form of the invention;

FIG. 5 shows a programmable control system according to a further alternate form of the invention;

FIG. 6 shows a programmable control system according to a further alternate form of the invention; and

FIG. 7 shows a plot of cycle time v. request package interval time for two settings of a wireless modem used in a system and process according to the invention.

### DESCRIPTION OF THE PREFERRED EMBODIMENT

The present invention provides systems which employ wireless EtherNet adapters, either as stand-alone devices or as embedded devices within a PLC to effectuate wireless communication between a plurality of PLC's.

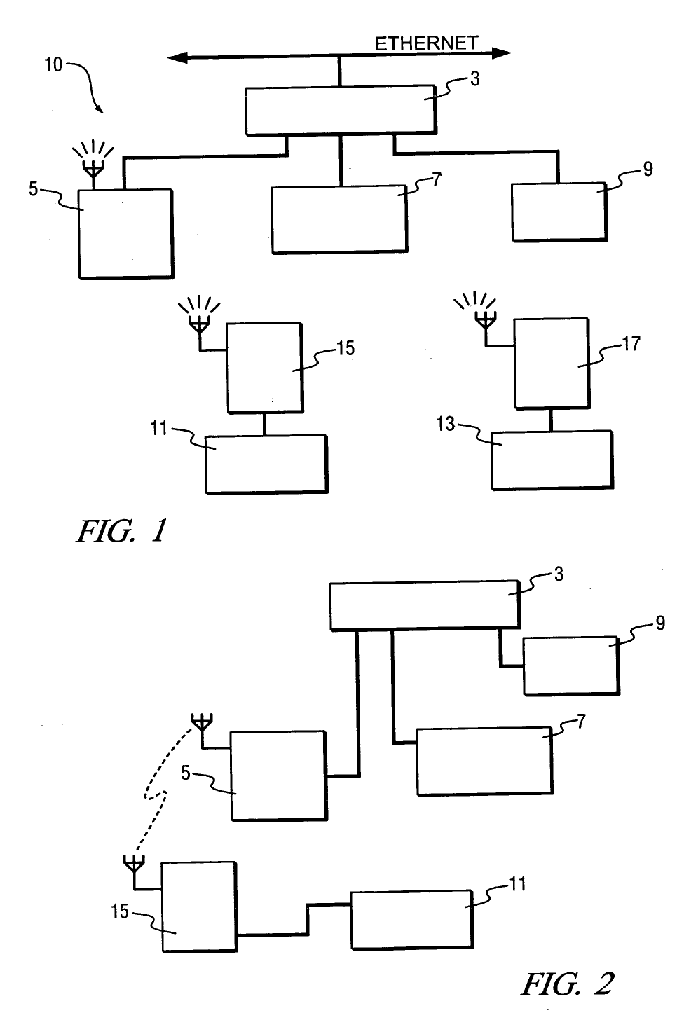

Referring to the drawings and initially to FIG. 1 there is shown a system for controlling the movements of various pieces of equipment associated with an industrial manufacturing process according to one form of the invention. In this FIG. 1 is provided a router/switch 3, which in one preferred embodiment is model number NR041 available from LINKSYS, Irvine, Calif., USA although other functional equivalent devices may be employed, having a cell programmable logic controller (“PLC”) 7 attached to it via a cable. In one preferred form of the invention, the cell PLC 7 is a ControlLogix 5555 PLC, available from Allen-Bradley division of Rockwell International, although other functional equivalent devices may be employed. The router/switch 3 may optionally be in effective electrical contact with an EtherNet cable, which is connected to a computer network having other elements (not shown) as part of a larger overall system.

Also connected to the router/switch in the embodiment of FIG. 1 is a computer interface 9, which may be a standard PC, MacIntosh, Linux, or other operating system-based laptop or desktop computer, as well as an access point (“AP”) wireless network adapter 5. In one preferred embodiment, the wireless network adapters, including the AP wireless network adapter just mentioned are model DWL 7100, available from D-Link Corporation of Fountain Valley, Calif.; however, the present invention also embodies the use of any other functionally-equivalent wireless network adapter capable of operating on the 802.11a standard. Such a configuration as that described enables an operator to enter one or more commands into the computer interface 9, either manually or by downloading a pre-configured software program, for controlling the output, action commands of the cell PLC 7, which may itself drive a piece of automated manufacturing equipment, including without limitation equipment such as a welding arm, robotic clamps, paint guns, conveyor belts, pneumatic controls, solenoids, motors, automated guided vehicle, automated guided cart, turntable, automated electric monorail, or other actuatable piece of hardware, as such are well-known to those skilled in the manufacturing arts. The computer interface 9 preferably includes a computer processor means for processing data, storage means for storing data on a storage medium, a means for initializing the storage medium, and a display means.

FIG. 1 also shows a second wireless network adapter 15 attached via cable to a first gate programmable logic controller 11, as well as a third wireless network adapter 17 that is attached via cable to a second gate programmable logic controller 13. The first and second gate programmable logic controllers 11 and 13 each serve as the driver for conveying commands to a piece of automated manufacturing equipment, per the above. Under such an arrangement as described, the combination comprising the second wireless network adapter 15 and first gate PLC 11 is a portable combination, which may be used to drive a piece of automated manufacturing equipment per the commands provided from the cell PLC 7 to the access point network adapter 5 and through the air via 802.11a protocol, where it is received at the wireless network adapter 15, thus transferring the command information to the programmable logic controller 11. The third wireless network adapter 17 and second gate PLC 13 combination is capable of an analogous function. By providing a plurality of wireless network adapters and gate PLC's, it is possible to provide a plurality of stations at which commands may be received from the cell PLC 7 for carrying, out a complex manufacturing operation involving several sequential and simultaneous operations. The wireless network adapters 15 and 17 may be model DWL 7100 from D-Link Corporation, including any functional equivalents thereof. The wireless network adapters 15 and 17 may be disposed at any location within range of the AP network adapter 5 which enables command information to be received by the network adapters 15 and 17 thus conferring a great deal of flexibility to exact configuration of the manufacturing operation of which such system is part. In this FIG. 1 and other figures, a solid line showing a connection between two component elements of the system is to be understood as meaning that the component elements are connected to one another using conventional wires and/or cables.

FIG. 2 shows a schematic diagram of a system useful for controlling a manufacturing operation according to an alternate form of the invention, which system comprises a router/switch 3, to which are connected a cell PLC 7 and computer interface 9, as well as an access point wireless Ethernet adapter 5. There is a remote sub-station, which comprises a wireless network adapter 15 that is connected to a gate PLC 11. During use of a system according to this embodiment, command information is transmitted under 802.11a protocol from the AP wireless Ethernet adapter 5, to the wireless adapter 15 and finally to the gate PLC 11, which controls one or more manufacturing operations.

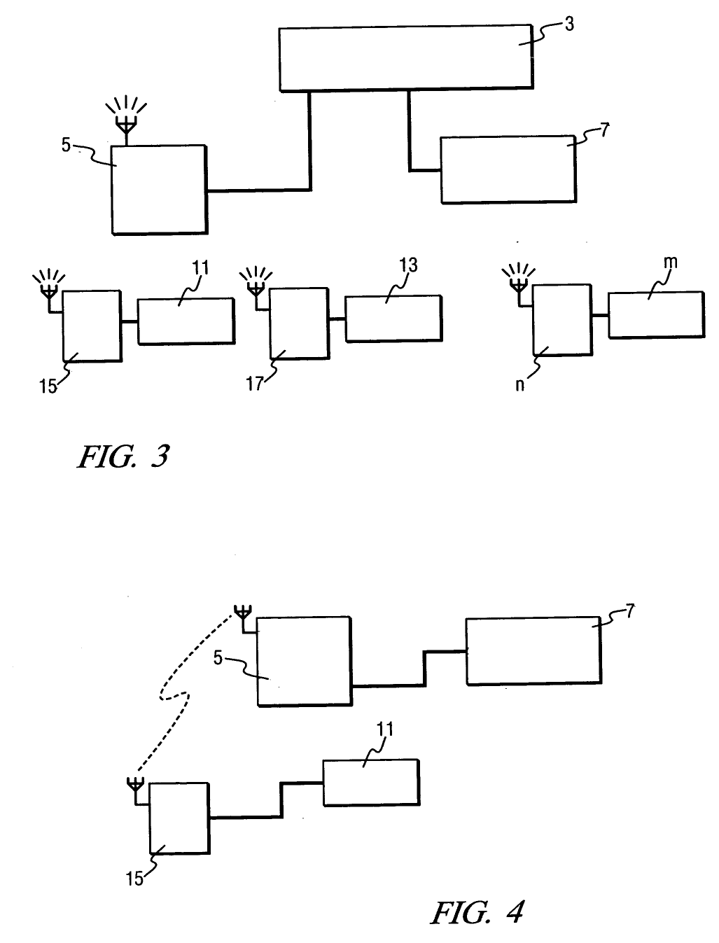

In FIG. 3 is shown a schematic diagram of a system according to another alternate form of the invention. In this FIG. 3 there is a router/switch 3 having a cell PLC 7 attached to it, as well as an Ethernet adapter 5. There is a first remote sub-station, which comprises a wireless network adapter 15 that is connected to a gate PLC 11. There is a second remote sub-station, which comprises a wireless network adapter 17 that is connected to a gate PLC 13. There is an n^{th} remote sub-station, which comprises a wireless network adapter n that is connected to a gate PLC m. Thus, it is seen that according to this embodiment, a single transmitting station, comprising the elements of router/switch 3, cell PLC 7, and Ethernet adapter 5 may be used to drive a plurality n of remote control sub-stations, which themselves comprise a wireless network adapter n that is connected to a gate PLC m. The PLC of such substations then each may control one or more steps or processes in a complex or simple manufacturing operation.

A system embodying a general principle of the present invention may enable communication between two or more programmable logic controllers, in the absence of a router/switch element 3 as specified in the foregoing schematics. Referring to FIG. 4 there is shown a first sub-station comprising a wireless network adapter 5 that is connected to a gate PLC 7 and a second sub-station comprising a wireless network adapter 15 that is connected to a gate PLC 11. The network adapters 5 and 15 may communicate with one another in an ad hoc mode via an 802.11a protocol, for synchronized or non-synchronized control of the programmable logic controllers 7 and 11, to cause desired control to be effected to a control device which is part of a manufacturing operation.

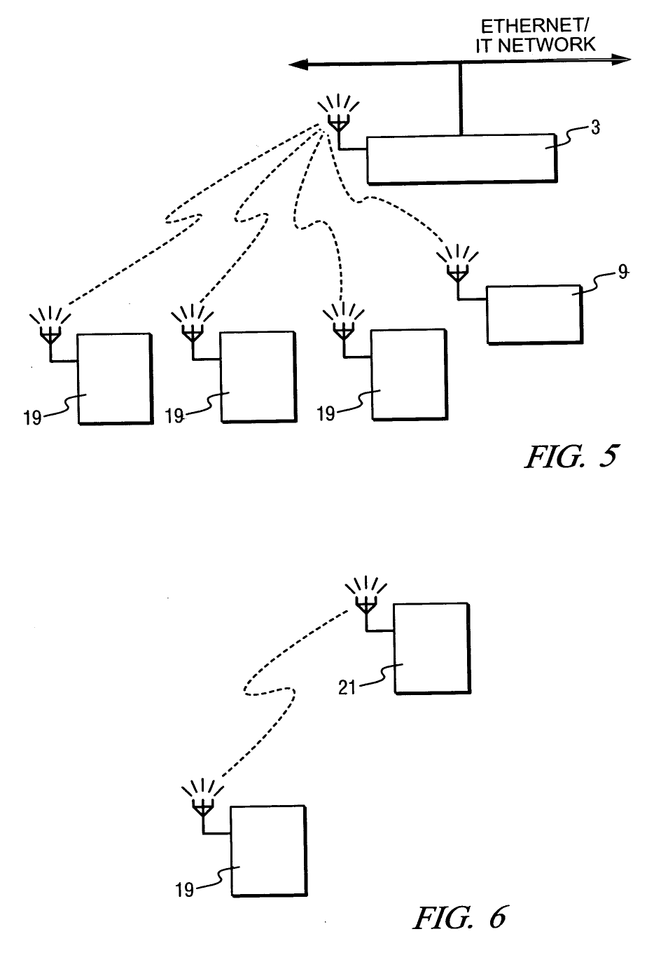

A schematic of a system according to yet a further embodiment of the present invention is specified in FIG. 5 in which router/switch 3 comprises an embedded wireless Ethernet adapter that utilizes the 802.11a protocol. The router/switch 3 is attached to an Ethernet, IT, or other computer network by a conventional patch cable. Such a system further comprises substations 19, each of which themselves comprise a programmable logic controller having an embedded wireless Ethernet adapter that operates under the 802.11a standard as a part of their construction. Such a system according to this embodiment further comprises a computer interface 9, which may as previously specified, comprise a conventional computer employing any operating system compatible with 802.11a protocols. Under such a system, a preferred embodiment comprises the situation when the computer interface is a laptop computer, which enables an operator to take advantage of the inherent portability when troubleshooting any difficulties associated with a manufacturing process that is controlled by one or more of the substations 19, each of which whose PLC's themselves provide control commands to a piece of manufacturing equipment.

FIG. 6 shows a schematic of a system according to yet a further embodiment of the present invention, comprising substations 19 and 21, each of which comprise an embedded wireless Ethernet adapter as part of their construction, in addition to a programmable logic controller. The network adapters 19 and 21 may communicate with one another in an ad hoc mode via an 802.11a protocol, for synchronized or non-synchronized control of the programmable logic controllers 7 and 11, to cause desired control to be effected to a control device which is part of a manufacturing operation.

For some time-critical control system/applications in manufacturing facilities, such as automobile assembly plants, there are situations in which only a low volume of data is required to be transferred to a PLC at the command-receiving end of a system according to the invention. However, the sensitivity to the random drop and delay associated with the transmitted signals are high. Compared to other wireless local area network applications of general purposes (e.g. file upload/download, internet access), a system according to the present will in general have a different requirement than for these systems, as specified in Table 1 below which is a comparison of requirements under 802.11a for different applications.

TABLE 1

| | General Purpose (e.g. | Time-Critical Control |
|---|---|---|
| | file up & down load, | (vehicle frame |
| Application | internet access) | fabricator) |
| Data Volume | Moderate to High | Low (<64 bytes) |
| Delay Sensitivity | Low (update rate >$$ | High (update rate <100 ms) |
| | seconds | |
| Respond in Time | >90% | >99% |
| Success Rate | | |

The PLC data round trip cycle time is an important indication of delay of data transmission. The selection of request package interval (“RPI”) will affect the traveling time of the data to be transferred. A large data traveling time may cause a controlled machine, which relies on the data input, not to be updated in time within a cycle time, and thus shutdown the production line.

A manual method for achieving desired tuning for a given size of data is readily accomplished by manually altering the RPI setting and measuring its corresponding cycle time. From empirical observations it is readily possible to select an RPI setting which results in lower cycle time for a given constraint of data throughput, if any.

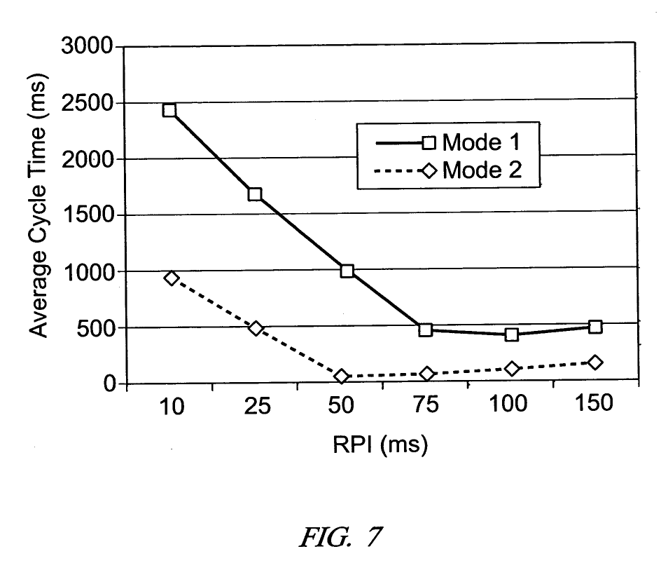

In FIG. 7, average cycle time in milliseconds is plotted as a function of RPI in milliseconds, from testing conducted using an Esteem 192E wireless modem (Electronic Systems Technology, Inc., Kennewick, Wash.) that was setup to transfer 4 bytes of data for each cycle. This wireless modem can be configured in two modes: Mode 1—EtherStation mode, and Mode 2—Access Point (AP) mode. FIG. 7 figure shows that, for both modes, the PLC cycle time was affected by RPI setting, and that the use of Mode 2 (AP mode) results in smaller PLC cycle time than using mode 1 for the same RPI setting and thus the mode 2 is a better choice than mode 1. Also, it shows that the setting of RPI=50 ms results in the least cycle time with Mode 2 and thus is the best setting in this particular case. Optimal settings may be readily determined using the same tuning methodology for different amounts of data to be transferred.

Owing to the versatility and flexibility in the number of possible configurations made possible through use of systems and processes afforded by the present invention, a wide range of manufacturing operations may be carried out using the instant systems and processes associated therewith. In general, the systems and processes of the present invention are applicable to single-step and multiple-step manufacturing operations in which one or more pieces of manufacturing equipment operate on a workpiece. A workpiece, as used herein, may comprise any material object which is the subject of a manufacturing operation, including without limitation, raw steel stock products which are to be bent in a manufacturing operation; sheet metal; beams; bar stock or other fabricated pieces which are to be joined, in a welding or riveting operation; sheet stock which is to be stamped, drilled or otherwise modified; finished wares which are to be made subject to surface treatments, including painting and anti-corrosion treatments; and materials which are conveyed from one location within a manufacturing facility to another via conventional conveying equipment, such as conveyor belts or lifts. Thus, in general, a workpiece is any article or component that is the subject of a manufacturing operation. It is therefore readily clear to one of ordinary skill after reading this specification that the systems and processes of the present invention are particularly well-suited for employment in the heavy industries, such as motorized vehicle manufacture, including without limitation automobile and truck manufacture, aircraft manufacture, marine manufacture; mining operations; steel manufacture; etc., further including any manufacturing operation utilizing one or more process steps in which a workpiece is fabricated, acted upon, or otherwise altered in either form or composition, such as motor vehicle frame fabrication.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. Accordingly, the presently disclosed invention is intended to cover all such modifications and alterations, and is limited only by the scope of the claims which follow.

1. A system useful for controlling a manufacturing operation, which system comprises:
a) a command-transmitting substation which comprises:
i) a network router, capable of functioning as a switch;
ii) a first programmable logic controller connected to said network router; and
iii) a first wireless network adapter connected to said network router, and
b) a command-receiving substation which comprises:
i) a second wireless network adapter; and
ii) a second programmable logic controller connected to said second wireless network adapter,
wherein said first wireless network adapter transmits electromagnetic signals containing command information to said second wireless network adapter acting as a receiver for said signals, under the 802.11a standard protocol, said router being optionally connected to a computer network.

2. A system according to claim 1 wherein at least one of said programmable logic controllers and wireless network adapter to which it is connected are both embedded in a single electronic device.

3. A system according to claim 1 further comprising at least a second command-receiving substation which comprises:
i) a third wireless network adapter;
ii) a third programmable logic controller connected to said third wireless network adapter,
wherein said third wireless network adapter receives signals from said first wireless network adapter under the 802.11a standard protocol.

4. A system according to claim 3 further comprising at least a third command-receiving substation which comprises:
i) a fourth wireless network adapter;
ii) a fourth programmable logic controller connected to said fourth wireless network adapter,
wherein said fourth wireless network adapter receives signals from said first wireless network adapter under the 802.11a standard protocol.

5. A system according to claim 1 further comprising a computer interface comprising a microprocessor, storage means and a display, wherein said computer interface is connected to said router via means of a cable.

6. A system according to claim 2 further comprising a second command-receiving substation which comprises:
i) a third wireless network adapter;
ii) a third programmable logic controller connected to said third wireless network adapter,
wherein said third wireless network adapter receives signals from said first wireless network adapter under the 802.11a standard protocol.

7. A system according to claim 6 further comprising at least a third command-receiving substation which comprises:
i) a fourth wireless network adapter;
ii) a fourth programmable logic controller connected to said fourth wireless network adapter,
wherein said fourth wireless network adapter receives signals from said first wireless network adapter under the 802.11a standard protocol.

8. A system useful for controlling a manufacturing operation, which system comprises:
a) a command-transmitting substation which comprises:
i) a first programmable logic controller;
ii) a first wireless network adapter connected to said first programmable logic controller;
b) a command-receiving substation which comprises:
i) a second programmable logic controller; and
ii) a second wireless network adapter connected to said second programmable logic controller,
wherein said first wireless network adapter transmits electromagnetic signals containing command information to said second wireless network adapter acting as a receiver for said signals, under the 802.11a standard protocol, and wherein said first programmable logic controller and said first wireless network adapter both are optionally embedded in a single electronic device.

9. A system according to claim 8 wherein said second programmable logic controller and said second wireless network adapter are both embedded in a single electronic device.

10. A process for controlling a manufacturing process that operates on a workpiece, which process comprises:
a) providing a programmable logic controller;
b) providing a piece of equipment useful in a manufacturing process, wherein said piece of manufacturing equipment is in effective electrical contact with said programmable logic controller sufficient that said programmable logic controller is capable of controlling the function of said piece of equipment;
c) providing a first wireless modem in effective electrical contact with said programmable logic controller;
d) providing a second wireless modem which is capable of communicating with said first wireless modem;
e) providing a computer interface in effective communicating electrical contact with said second wireless modem;
f) transmitting a function command from said second wireless modem to said first wireless modem, sufficient to cause an action in said piece of equipment,
wherein said first wireless modem and said second wireless modem communicate using the 802.11a wireless standard.

11. A process according to claim 10 wherein said manufacturing process is a multi-step manufacturing process involving the operation of a plurality of pieces of manufacturing equipment on a workpiece, and wherein step c) further comprises providing a plurality of wireless modems, each in effective electrical contact with a programmable logic controller that is associated with at least one step in said manufacturing process.
